(19) United States
(12) Patent Application Publication
(10) Pub. No.: US 2015/0006072 A1
(43) Pub. Date: Jan. 1, 2015

(54) Dynamically Optimized Transportation System

(71) Applicants: Jeremy Kasile Goldberg, New York, NY (US); Jonathan Davis Seder, Palo Alto, CA (US)

(72) Inventors: Jeremy Kasile Goldberg, New York, NY (US); Jonathan Davis Seder, Palo Alto, CA (US)

(21) Appl. No.: 14/176,108

(22) Filed: Feb. 9, 2014

Related U.S. Application Data
(60) Provisional application No. 61/841,376, filed on Jun. 30, 2013.

(51) Int. Cl. G06Q 50/30; G06Q 10/02; G01C 21/26

(52) U.S. Cl. CPC G06Q 50/30; G01C 21/26; G06Q 10/02
USPC 701/408; 701/400; 705/5

(57) ABSTRACT

A comprehensive system to optimize utilization of transportation resources, including public vehicles such as municipal buses, quasi-public vehicles such as university and corporate campus shuttles, private vehicles, and freight carriers (all participating vehicles collectively, “Transportation Assets”) and provide superior, expedient, efficient, and economical transportation options to prospective passengers or cargo items (each, a “Rider”). A central tracking and guidance system (the “Coordination System”) will monitor the current itineraries, present locations, capabilities, and operator-designated preferences of Transportation Assets. A Rider seeking transportation will be directed to a point of rendezvous with a Transportation Asset on the basis of computer or smartphone-provided destination and price preference information given by such Rider, and such Rider's mobility. Transportation Asset routing, Rider guidance prior to and during utilization of Transportation Assets, and pricing will be dynamically determined on the basis of the existing itineraries of Transportation Assets, the ability of Riders to travel en route to use of a Transportation Asset, and capacity utilization of Transportation Assets. All participants in the system may dynamically adjust their preferences in response to pricing information, so the system will be continuously optimized.

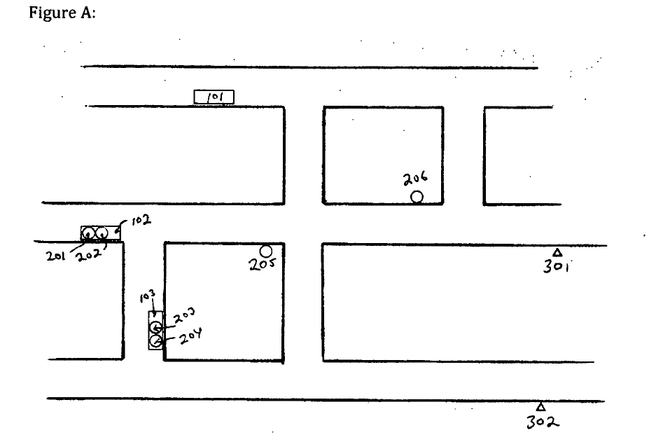

### FIELD OF THE INVENTION

The present invention relates generally to the area of provision of shared transportation. More specifically, it relates to techniques for optimizing the utilization of Transportation Assets, the pricing of amounts to be paid for Riders of such Transportation Assets, and techniques for optimizing the practices of such Riders of Transportation Assets.

### BACKGROUND OF THE INVENTION

Portable electronic devices with high-speed data communications, highly accurate position sensors, and powerful computing capabilities are now in very wide usage as mobile telephones, tablets, and similar devices carried by individuals. These same devices, as well as similar devices specifically designed for transportation purposes, are widely deployed on a temporary or permanent basis in private and public vehicles for the provision of transportation and way-finding information.

Additionally, detailed mapping services are in general personal and commercial use. These mapping services coordinate Rider requests for route-finding, including the utilization of private or public transportation, taking into account Rider preferences with regard to maximum route complexity, Rider mobility, timing, and with regard to public transportation, temporary changes in service and other relevant current information.

Further, real-time traffic reporting services are widely used to track the progress of private and public vehicles. In conjunction therewith, existing technological developments permit continuous monitoring of the locations and progress of numerous private and public vehicles.

Customers today can use systems hosted on centralized servers, available through ubiquitous networks, to plan trips on scheduled transport services, and to make reservations and purchase tickets on those systems. Customers can also use systems hosted on centralized services to request taxi or limousine services; by naming start and end locations, they can then obtain pricing information and also reserve and purchase seats on such vehicles. Customers can further purchase shared rides, typically to a commonly shared destination such as an airport, under a system in which the service vendor declares a maximum number of possible stops and makes other statements with regard to the nature and quality of service provided.

### SUMMARY OF THE INVENTION

The operation of public or quasi-public transportation vehicles is largely consistent through the United States and internationally, across public transit systems, universities, corporate and governmental campuses, and other areas in which non-private transportation services are provided. These public or quasi-public transportation vehicles operate along a predetermined route, in many cases stopping to take on and drop off Riders only at predetermined points on such route, and often on a fixed schedule. The procedures described in the preceding sentence have not evolved significantly in more than seventy years. Due to the recent proliferation of a number of distinct technologies, and personal-level devices harnessing such technologies, the provision of commercial transportation services can be greatly improved.

Under this invention, Transportation Assets will be equipped with a location device that provides frequent location information to the Coordination System, an Operator-facing device that provides turn by turn directions and notifications regarding Rider pickup and drop off locations and timing therefor. Existing turn-by-turn direction systems, whether included in personal electronic devices and Transportation Asset based, would fulfill much of the necessary role. Such location devices would provide continuously updated information to the Operator of each Transportation Asset with regard to the route to be taken, stops to be made to take on or let off Riders, and in some circumstances also requests from potential Riders for pricing and timing information for such Riders' proposed trips.

Riders will utilize an application on a smartphone or similar device, or less optimally, will utilize a similar application on a desktop or laptop computer or other device. Through such application, each such Rider will provide information regarding his present location, his desired destination, and the rate and maximum distance he would be willing to travel prior to and after each utilization of a Transportation Asset Several additional components may additionally, or alternately, be included. Such Rider could also provide information with regard to the pricing acceptable to him expressed as absolute values or as functions of options such as time, intermediate stops, or number of other passengers; and could in some applications engage in a bilateral negotiation with individuals affiliated with Transportation Assets. Information with regard to such Rider's rate and maximum distance of travel prior to, or after, usage of a Transportation Asset could be based on such Rider's past usage or Rider-provided information regarding mobility, for example, possession of a bicycle. A Rider could further indicate his preference for a journey of shorter duration relative to a journey with fewer transfers or less travel prior to, or after, usage of a Transportation Asset A Rider could additionally indicate large packages, companions, palletized or bulk freight, or other information that would affect his use of a Transportation Asset

In this invention, a Coordination System will gather information provided by Transportation Assets regarding their current intended routes and current Rider pick-up and drop-off obligations together with the information provided by Riders not presently being carried by such Transportation Assets. The Coordination System will dynamically direct Transportation Assets to reflect the present circumstances of all Riders currently being transported or seeking carriage by a Transportation Asset

The Coordination System will direct Riders awaiting transportation to proceed to Rider-specific pick-up areas within a given timeframe. Where such a Rider is equipped with a smartphone or similar device, his location, reflective of his progress toward such Coordination System-directed pick-up point, would update on a frequent basis. Where a Rider's progress deviated from that route to the pick-up point directed initially by the Coordination System with regard to rate and/or direction, the Coordination System would redirect Transportation Assets and such Rider to re-optimize system utilization. Where a Transportation Asset's progress with regard to rate and/or direction deviated from that anticipated following the provision of initial directions to a Rider by the Coordination System, the Coordination System would similarly redirect Transportation Assets and Riders to re-optimize system utilization.

Each Operator, or an affiliate thereof, has provided to the Coordination System a profile of its Transportation Asset as well as logistical and economic data with regard to such Transportation Asset's planned operation in the context of this transportation system. Such Transportation Asset profile information might include passenger or freight capacity; special access capabilities for disabled Riders; and special comfort features such as luxurious or extra-large seats, power points, and data network capability. Such economic information might include expected payment rate per operating mile, payment per stop, payment for waiting time, and opportunity cost for idle time. These parameters may be adjusted in real time. As precursor conditions to participating in the Coordination System as a Transportation Asset, the Operator, or an affiliate thereof, of each Transportation Asset has also provided information to enable payment for services, and proof of insurance therefor. As one aspect of such confirmation process, each potential Operator of each Transportation Asset has provided requisite legal documentation, which may include proof of driver's licenses, proof of insurance, and/or other documentation or certification, as required by the applicable jurisdiction(s). The Coordination System may collect and report Rider feedback for each Operator, and adjust system pricing and routing to favor highly regarded Operators.

Each Rider will, as a condition to use of this transportation system, have also registered with the Coordination System. Such registration will include provision of payment information, designation of acceptable and preferred transportation options, and the designation of other requirements and preferences, such as wheelchair accommodation or internet connectivity. These preferences and requirements could be modified subsequently by such Rider. A Rider's history of timely compliance with promised itineraries and prompt payment may be collected by the Coordination System and used to manage the Coordination System for best performance.

Each Rider, in accepting carriage by a Transportation Asset, further agrees to an offered price of the trip and possible adjustments for additional parameters which might include intermediate stops above a certain number, the number of other Riders on the Transportation Asset above a certain threshold, and delays beyond estimated arrival time caused by adding Riders and stops and additional travel distance to accommodate those Riders. Riders may also be subject to penalties if they fail to appear at the pick-up point or otherwise delay or interfere with the efficient operation of the Coordination System.

In assigning Rider rides, the Coordination System will take into account each Operator's stated operational hours and break times, as well as mandated rest periods and maximum work hours, and refueling events. That is, if an Operator is to have a periodic break (e.g., fifteen minutes every two hours), then rides will not be offered that would impinge on that break time, and the Coordination System will attempt to accept rides that terminate close to the break time and possibly leave the Operator in a preferred break location.

Message Protocol Overview

In the preferred embodiment of this system, communications between Riders, Transportation Assets, and the Coordination System will be implemented through messages sent to and from the Coordination System. Riders and Transportation Assets will not communicate directly (except possibly in “exception” handling, where a Transportation Asset or Rider might be unable or unwilling to communicate with the Coordination System).

These messages will be transmitted using message-queuing, encryption, authentication, and serialization techniques which are described in many other patents and are in common use.

Messages from the Rider

Request Ride—rider_id, start_point, end_point, start_time, parameter_overrides
In response, the Coordination System evaluates the possible ride options and responds with a set of “Ride offer” messages. Ride options are evaluated by applying the preference functions of the Riders and Transportation Assets to the best new computed routes.

Accept Offer
In response, the Coordination System debits the Rider's payment account, sends an “Action: go-to” message to the Rider to lead them to the rendezvous point, and sends path guidance (such guidance, a “Driving Direction”) to the selected Transportation Asset(s).

Ride_Action: load, unload
The last rendezvous message sent by the Coordination System will prompt the Rider to acknowledge that he has boarded; this message transmits the acknowledgement. Similarly, as the Rider approaches the destination he will receive a prompt requesting acknowledgement which will trigger the “unload” message.

Exception: withdraw, transportation-asset-no-show, early-termination, transportation failure, safety emergency, other problem
This group of messages is used to trigger exception processing by the Coordination System. A Rider or Transportation Asset no-show report might trigger, new rendezvous instructions for a Rider no show, or a contact phone number for the Transportation Asset's Operator or a new set of ride offers for a Transportation Asset no-show. Early termination will trigger a corresponding billing adjustment and a dialog to establish the reason for termination.

Current Status
The Rider's communications device will transmit this message in response to a “Request current status” message from the Coordination System. This response might be generated automatically by the Rider's communications device, or (if, for example, a GPS signal is unavailable because of foliage or tall buildings) use data entered manually by the Rider.

Messages to the Rider

Ride Offer
In response to the “Request ride” from the Rider, the Coordination System will generate a menu of alternatives and transmit these to the Rider in a bundle of “Ride offer” messages. These messages will be encoded with expiration times based on availability of Transportation Assets in motion, and may have continuously varying prices to reflect changing circumstances over time.

Act: go-to, load, unload
When a Rider accepts an offer, the Coordination System will respond with a series of commands to instruct the Rider in the appropriate way to reach their destination. The Rider's compliance with these instructions may be monitored locally with periodic acknowledgements transmitted to the Coordination System and certain exceptions: for instance, a wrong turn in walking instructions, which might be processed locally rather than transmitted to the Coordination System centrally.

Exception: asset-delay, withdraw
If the Coordination System cannot fulfill an accepted ride because of an exception, it will transmit an exception notification message to the Rider alerting them to a delay or inability to perform.

Request Current Status
If the Rider appears to have failed to follow instructions or communications have been interrupted, this message might be sent to request a status update. This message will contain position, direction, speed, and transportation modality information.

Messages From an Asset

Current Status
The Transportation Asset uses this message to notify the Coordination System that it is available for service; that it is not available for service temporarily or until further notice. This message may also contain location, direction, speed, number of passengers on board, and other pertinent data.

Confirm Rider Load, Unload, Out-of-Service, In-Service, Refuel
This short-form variation on the “Current status” message is used to confirm a specific instruction from the Coordination System.

Driving Direction Override
This message informs the Coordination System that the Transportation Asset Operator has varied from a route instruction, perhaps because of traffic or road closure. This message may be generated automatically by the Transportation Asset's communications device, but is transmitted only after the Transportation Asset Operator acknowledges the exception. This message format is also used to confirm that the Transportation Asset Operator has received a change in previously transmitted instructions.

Preference Update
Because of traffic conditions, fuel availability, additional business opportunities, or other factors, the Transportation Asset Operator may wish to adjust a parameter in the pricing function. This message enables this adjustment.

Exception: out-of-service (fuel stop, accident, equipment failure, operator issue, rider no-show, safety emergency, other problem)

This message is transmitted if the Transportation Asset must be taken out of service. The Coordination System may attempt to resolve this by offering alternate transportation to any Riders, but certain emergencies may require intervention by human controllers.

Messages to an Asset

Driving Direction
This message directs a Transportation Asset Operator to proceed to a location to pick up or drop off a Rider. In the preferred embodiment of this invention, a series of instructions is sent to the Transportation Asset's communications system and the instructions are presented serially, as appropriate, to the Transportation Asset's Operator. If the Transportation Asset's Operator varies from the Driving Directions, the communications system may try to recover without interacting with the Coordination System.

Driving Direction Override
This message is used to alert the Transportation Asset Operator of a change in previously transmitted instructions. The Transportation Asset's Operator responds with a “Driving direction override” confirmation message.

Rider Load, Unload
These messages are used to instruct the Operator to pick up or discharge a Rider. The Transportation Asset's Operator responds with a “Confirm rider load, unload” message.

Other Operations
This message is used to instruct the Transportation Asset's Operator to take personal break time (possibly accompanied by instructions for access to rest facilities), to make a fuel or maintenance stop, to go out of service because no Riders are bidding, and/or for other non-transportation actions.

Request Current Status
This message is transmitted if the Transportation Asset has failed to respond to a message that requires confirmation, or if the Coordination System detects that the Transportation Asset has varied from the instructed course, or if automated GPS is not available.

Typical Message Sequences
The following illustrates a preferred embodiment of the messages that pass between the communications devices carried between the Rider, the Transportation Asset's Operator, and the Coordination System. This is a simplified example which shows only one Rider and a single simple journey. The preferred embodiment of the invention will support other conversations with other Riders and Transportation Asset Operators, and also process the many exception conditions which may arise in any actual implementation.

In the preferred embodiment, directions provided to each Rider and Transportation Asset Operator will be updated at each decision point, or when there is some exception such as detection of an off-course diversion, determination of a route improvement due to traffic delay, equipment failure, abandonment by a Rider or Transportation Asset, or other exception.

In the preferred embodiment, GPS location will be able to verify that Riders and Transportation Assets are complying with system instructions.

| Message direction | Message content |
|---|---|
| User→System | Request ride, home to work, within 20 minutes |
| System→User | Ride offers |
| User→System | Accept one offer |
| | Note: At this point, the Coordination System |
| | computes expected route progress for both |
| | Rider and Transportation Asset. Failure by |
| | either Rider or Transportation Asset to |
| | progress according this plan will trigger |
| | exception processing. |
| System→User | Proceed to rendezvous, with a series of |
| | messages to direct the Rider to the rendezvous |
| System→Transport | Proceed to rendezvous, Rider load |
| System→Transport | Driving Directions |
| User→System, | Position update (repeated at an interval of |
| Transport→System | time or distance) |
| User→System, | Rider load |
| Transport→System | |
| System→Transport | Proceed to destination |
| User→System, | Position update (repeated at an interval of |
| Transport→System | time or distance) |
| User→System, | Rider unload |
| Transport→System | |

In the messages specified above, delivery may be made to the Coordination System by a portable electronic device as a result of an inputted command made by a Rider or an Operator, or on an automated basis with regard to conditions detected by the sensors contained in the Coordination System or any of its constituent parts, including portable electronic devices possessed by a Rider or an Operator.

In the preferred embodiment of this invention, optional choices are presented to the Rider and the Operator through display screens, and the Rider and the Operator make selections to express preferences with regard to such optional choices.

To assert default preferences in the preferred embodiment, the Rider's hand-held device would make it possible to assert a vehicle type (with the option to include and/or exclude one or more from a list of transportation options, potentially including options as “limousine”, “taxicab”, “8-12 passenger bus”, and “large bus”). Similarly, the Rider's hand-held device would permit such Rider to assert a preference for (i) one or more of the following route options, among other: “shortest time”, “shortest distance”, “fewest transfers”, “lowest cost”, or “no preference”; and/or (ii) one or more of the following ride options, among others: minimum and/or maximum acceptable number of other Riders and other passengers, the preferred number of stops to pick up and drop off other Riders or other passengers, maximum walking distance, maximum walking time, and acceptable number of transfers. With regard to preferences of a Rider, including those specified above, such Rider may assert any selections by performing an appropriate action to save them for future uses (for example, by selecting a button labeled “Save”).

To request transportation in the preferred embodiment, the Rider's device would present a rider_id, start_point, end_point, start_time, and certain other parameters all set to the Rider's previously expressed default choices, if saved per the paragraph immediately above. As defaults in the preferred embodiment, the rider_id is a previously registered identity token; the start point is the address or map presentation of the Rider's current position; the end_point is an address entry field; the start time is the current time; other parameters could non-exclusively include vehicle type, route option, acceptable number of other riders, acceptable maximum number of intermediate stops; maximum acceptable walking distance, and maximum acceptable number of transfers from one Transportation Asset to another. The Rider may override any of the preset values. The Rider would specify an end_point either with an address auto-complete mechanism (under which the hand-held device offers suggestions which match whatever address information the Rider has entered), or through complete input of an address, or through entry by means of locating a point on a graphical map. When the Rider is satisfied with the choices, they might execute the request by selecting an on-screen button, perhaps labeled “Request Ride”.

In response to the Rider's request, as outlined in the Summary of the Invention above, the Coordination System responds with a set of alternative “Rider Offer” messages. Each of these is accompanied by details including, but not limited to, transportation modalities, projected elapsed time, number of transfers, number of stops, number of other riders, and prices. The Rider's portable electronic device presents these alternatives as a list among which the Rider is given a means of selection possibly implemented as a “Select and Pay” button attached to each option's displayed data. When the Rider selects the option, the portable device sends an “Accept Offer” message.

In responses to the Rider's Accept Offer message, the Coordination System transmits a set of “Act: go to”, “Act: load”, and “Act: unload” messages to the Rider's portable device which displays these to instruct the Rider. In one embodiment, these instructions might consist of
Walk 100 feet north to the southeast corner of Elm St and Spruce St (“Act: go to”)
Take the eastbound #35 bus ($2 fare) (“Act: load”)
Get off the bus at the southeast corner of Elm St and Pine St ($2 fare) (“Act: unload”)
Board jitney A25 ($4 fare) (“Act: load”)
Get off the jitney at 825 Main St (“Act: unload”)
Time to destination: 35 minutes
Total fare: $6.00

### BRIEF DESCRIPTION OF THE DRAWING

Various embodiments of the invention are disclosed in the following detailed description and the accompanying drawing.

### DETAILED DESCRIPTION OF THE INVENTION

Figure A permits a description of an enabling embodiment of the best mode of invention.

Figure A shows a schematic street system, not drawn to scale.

Elements 101, 102, and 103 are Transportation Assets, operated by Operators.

Elements 201 through 204 are Riders currently being transported on Transportation Assets. Elements 205 and 206 are Riders who have indicated to the Coordination System that they wish to be transported.

Elements 301 and 302 are destination points that have been indicated by Riders

In Figure A, Transportation Asset 101 is parked, awaiting utilization. Transportation Asset 102 proceeding toward Point 302 and carrying Riders 201 and 202. Transportation Asset 103 is proceeding toward Point 301.

Rider 205 would like to be transported to Point 302. This Rider uses a portable electronic device to send this request to the Coordination System. The sending device identifies Rider 205 and provides Rider 205's current location to the Coordination System. Rider 205 is prompted to specify his desired destination. The Coordination System identifies that Transportation Assets 101, 102, and 103 are each capable of providing Rider 205 with transportation services.

The Coordination System applies the current location, mobility, and requested destination for Rider 205 against the profiles for Transportation Assets 101, 102, and 103, the positions of those Transportation Assets, and the parameters of the Riders currently on board those Transportation Assets, and offers Rider 205 three alternatives: (1) a non-stop ride in Transportation Asset 101, directly from Rider 205's current location or another more expedient location that Rider 205 would be able to reach prior to the arrival thereto of Transportation Asset 101 for a high charge; (2) a ride in Transportation Asset 103 from a location that Rider 205 could reach prior to the arrival of Transportation Asset 103 at such same pick-up location, and to a drop-off location that reflects a compromise between the general efficiency of such Transportation Asset 103's general route and minimization of the distance from such drop-off location to Rider 205's requested destination for an intermediate charge; or (3) a ride in Transportation Asset 102 with several intermediate stops, and a walk of some distance from Rider 205's current location and from the end of the bus ride to Point 302. The price of the ride in Transportation Asset 102 would be determined by the economic profile of Transportation Asset 102 and also by parameters set by Riders 201 and 202, who may receive netted compensation from Transportation Asset 102 if carriage of Rider 205 would result in any detour from the previous route and/or additional stops.

In this hypothetical, Rider 205 chooses to accept the offered ride from Transportation Asset 103. The Operator of Transportation Asset 103 is immediately informed by his onboard directional device to turn right and stop at a provided location to pick up Rider 205. Rider 205 is directed to proceed to the same location for pick-upThe Coordination System will continue to send turn-by-turn driving instructions as well as pick-up and drop-off commands to Transportation Asset 103.

PATENT CITATIONS

| | Filing | Publication | | |
|---|---|---|---|---|
| Cited Patent | Date | Date | Applicant | Title |
| 5,610,821 | Nov. 18, | Mar. 11, | Denos C. Gazis; | Optimal and stable route planning system |
| | 1994 | 1997 | Robert S. Jaffe; | |
| | | | William G. Pope | |
| 5,799,263 | Apr. 15, | Aug. 25, | Russell D. | Public transit system and apparatus and |
| | 1996 | 1998 | Culbertson | method for dispatching public transit |
| | | | | vehicles |
| 6,480,783 | Mar. 17, | Nov. 12, | David Myr | Real time vehicle guidance and forecasting |
| | 2000 | 2002 | | system under traffic jam conditions |
| 20050004757 | Jul. 22, | Jan. 6, | Teddy Neeman; | Method and control, means for route |
| | 2002 | 2005 | Doron Shalev | planning in a mass transport system |
| 20110093301 | Oct. 15, | Apr. 21, | Jamie Walker | System and method for negotiating a |
| | 2009 | 2011 | | shared flight itinerary |
| 7,957,871 | Sep. 29, | Jun. 7, | Chinedu Echeruo | Methods and apparatuses for navigation in |
| | 2005 | 2011 | | urban environments |
| 8,140,256 | Aug. 16, | Mar. 20, | Sean J. Barbeau; | Dynamic ride matching system |
| | 2007 | 2012 | Sasha dos-Santos; | |
| | | | Miguel Labrador; | |
| | | | Rafael Perez; | |
| | | | Philip L. Winters | |
| 8,188,859 | Jan. 16, | May 29, | Aaron T. Emigh | Navigation assistance for a passenger on a |
| | 2012 | 2012 | | public conveyance |
| 8,255,159 | Jan. 6, | Aug. 28, | Christopher J. | Transit payment and handset navigation |
| | 2009 | 2012 | Bierbaum; | integration |
| | | | Robin D. Katzer; | |
| | | | Todd N. Koellner; | |
| | | | Kevin Zhu | |
| 8,285,570 | Aug. 27, | Oct. 9, | Jeffrey Chernick; | Matching system for ride reservation |
| | 2010 | 2012 | Ben Dalton; | platforms |
| | | | Evan Meyer | |
| 8,392,110 | Oct. 25, | Mar. 5, | Mark Schunder | Conservational vehicle routing |
| | 2011 | 2013 | | |

1. A Coordination System that continuously monitors the locations and directs the movements of (i) Transportation Assets and (ii) those Riders currently awaiting or aboard a Transportation Asset

2. A mechanism to exchange information between the Coordination System and the Transportation Assets and to provide instructions to the operators thereof (“Operators”), such information including preferential payments for units of time and distance, for stops, for luggage handling, and any geographical restrictions.

3. A mechanism by which Operators and Riders can express preferential payments as simple parameters (e.g., dollars per mile) or as algorithmic parameters (e.g., a function of miles, stops, average speed, and maximum Rider count), or through an Operator-provided external computer system which responds to specific pricing requests with specific, non-negotiable responses.

4. A mechanism by which the Coordination System can direct each Operator to the next Rider pick-up or drop-off point, including turn-by-turn directions, rest time and refueling directives, and pick up or drop off instructions.

5. A mechanism to exchange information between the Coordination System and Riders, by means such as a smartphone application, to communicate each Rider's general preferences and each Rider's specific transportation requests, with the origination point for each such request potentially defaulting to the corresponding Rider's location at the time such request is made.

6. A Coordination System which can accept, store, and evaluate Rider and Operator preferences which have been described as an explicit set of parameters, or algorithmically, or with specific bids in response to service offerings.

7. A Coordination System which can evaluate route preferences according to options which may include the number of passengers; the number of stops between pick up and drop off points; the number of transfers; the total travel time, possibly expressed probabilistically (e.g., “30+5/−5 minutes versus 20 +20/−5 minutes”); the walking distance at endpoints or transfer points; and the acceptable Transportation Asset capacity or other characteristics.

8. A Coordination System which, in response to a request by a Rider for transportation services, analyzes the positions and routes of Transportation Assets and presents such requesting Rider with a menu of choices with associated prices computed according to preferences provided by Riders and Operators.

9. A route option menu showing feasible routes with an accompanying prices, each calculated with respect not only to the options presented to each Rider, but also to the implications for other Riders and for Operators, for exposure to traffic delays, for delays related to luggage handling, and other factors which affect other passengers, Operators, and other parties directly or indirectly.

10. A route option menu which is computed with respect to yield-maximization, such that profit margins are adjusted to provide optimized gross margins or optimized Transportation Asset utilization.

11. A Coordination System which directs the Rider to a point of rendezvous with a selected Transportation Asset (such rendezvous point may be the Rider's current location).

12. A Coordination System which continuously monitors the position of each Rider, and, for each Rider, continuously updates the point of rendezvous, and offers new instructions to the Operator of the selected Transportation Asset if such Rider deviates from the directed course or proceeds more or less quickly than anticipated at the time of determination of the point of rendezvous.

13. A Coordination System which offers continuously optimized choices to all Riders in such Coordination System to select transportation options which reflect the continuously changing possibilities and costs.

14. A Coordination System which enables Riders to describe additional characteristics of other items to be transported (other than people and accompanying luggage) such as packaged or bulk freight, perishable or durable, and thus to solicit and accept bids, while transportation providers dynamically reconfigure and re-route Transportation Assets.

15. A Coordination System which uses historical performance of Operators and Riders, and/or subjective assessments provided by Riders and Operators of Operators and Riders, to optimize price, performance, and yield, offering, for example, a higher level of service to Riders who have previously shown high levels of punctuality or other desirable behaviors, and assigning more riders to Operators that meet quality standard thresholds.

16. A Coordination System that enables Riders and Operators to use a means of expressing a preference and a willingness to pay more, or charge less, respectively for higher-rated Operators or Riders.
